(19) United States
(12) Patent Application Publication
(10) Pub. No.: US 2025/0104521 A1
(43) Pub. Date: Mar. 27, 2025

(54) ELECTRONIC GAME WITH MULTIPLE REEL AREAS AND PERSISTENT BLOCKING SYMBOLS

(71) Applicant: Aristocrat Technologies, Inc., Las Vegas, NV (US)

(72) Inventors: Erick Ching, Cedar Park, TX (US); Rogelio Decasa, JR., Renton, WA (US); Jennifer Mizzi, Ewa Beach, HI (US); Hanna Sanborn, Georgetown, TX (US); Nathan Warms, Austin, TX (US)

(21) Appl. No.: 18/372,992

(22) Filed: Sep. 26, 2023

(51) Int. Cl. G07F 17/32

(52) U.S. Cl. CPC G07F 17/3267; G07F 17/3213

(57) ABSTRACT

An electronic gaming machine includes a display device for an electronic game that includes first and second reel areas, and a game controller configured to cause display of symbols including feature symbols in the first and second reel areas as part of a base game mode, determine that the first reel area includes a triggering number of the feature symbols for triggering a feature game mode and that the second reel area does not include the triggering number of the feature symbols, cause display of a visual indication that the second reel area is inactive for a feature game initiated in the first reel area, and upon conclusion of the feature game, cause the feature symbols to be removed from the first reel area, and cause display of a visual indication that the second reel area is reactivated while maintaining the feature symbols in the second reel area.

### TECHNICAL FIELD

The field of disclosure relates generally to electronic gaming, and more particularly, to systems and methods for providing an electronic game including multiple reel areas and persistent feature symbols that block winning symbol combinations and trigger a feature game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming machine is provided. The electronic gaming machine includes at least one display device configured to display an electronic game that includes a first reel area and a second reel area, and a game controller configured to execute instructions stored in at least one memory. The instructions, when executed, cause the game controller to: cause display of a plurality of symbols including one or more feature symbols in each of the first and second reel areas as part of a base game when in a base game mode: determine that the first reel area includes a triggering number of the feature symbols displayed therein for triggering a feature game in a feature game mode: initiate the feature game within the first reel area: determine whether the second reel area includes the triggering number of the feature symbols displayed therein: in response to the second reel area not including the triggering number of the feature symbols, cause display of a visual indication that the second reel area is inactive for the feature game; and upon conclusion of the feature game: generate a feature game award; and cause return to the base game mode including (i) cause the feature symbols to be removed from display in the first reel area, and (ii) cause display of a visual indication that the second reel area is reactivated while maintaining the display of the feature symbols in the second reel area when the second reel area does not include the triggering number of the feature symbols. The instructions may direct additional, less, or alternate functionality, including that discussed elsewhere herein.

In another aspect, a non-transitory computer-readable medium containing instructions stored thereon is provided. The instructions, when executed by a processor, cause the processor to: control at least one display device to display an electronic game that includes a first reel area and a second reel area; control the at least one display device to display a plurality of symbols including one or more feature symbols in each of the first and second reel areas as part of a base game in a base game mode: determine that the first reel area includes a triggering number of the feature symbols displayed therein for triggering a feature game in a feature game mode: initiate the feature game within the first reel area: determine whether the second reel area includes the triggering number of the feature symbols displayed therein: in response to the second reel area not including the triggering number of the feature symbols, control the at least one display device to display a visual indication that the second reel area is inactive for the feature game; and upon conclusion of the feature game: generate a feature game award; and cause return to the base game mode including controlling the at least one display device to (i) remove the feature symbols from display in the first reel area, and (ii) display a visual indication that the second reel area is reactivated while maintaining the display of the feature symbols in the second reel area when the second reel area does not include the triggering number of the feature symbols. The instructions may direct additional, less, or alternate functionality, including that discussed elsewhere herein.

In another aspect, a computer-implemented method for providing an electronic game on an electronic gaming device is provided. The method includes: controlling at least one display device to display the electronic game that includes a first reel area and a second reel area: controlling the at least one display device to display a plurality of symbols including one or more feature symbols in each of the first and second reel areas as part of a base game in a base game mode; determining that the first reel area includes a triggering number of the feature symbols displayed therein for triggering a feature game in a feature game mode: initiating the feature game within the first reel area: determining whether the second reel area includes the triggering number of the feature symbols displayed therein: in response to the second reel area not including the triggering number of the feature symbols, controlling the at least one display device to display a visual indication that the second reel area is inactive for the feature game; and upon conclusion of the feature game: generating a feature game award; and causing return to the base game mode including controlling the at least one display device to (i) remove the feature symbols from display in the first reel area, and (ii) display a visual indication that the second reel area is reactivated while maintaining the display of the feature symbols in the second reel area when the second reel area does not include the triggering number of the feature symbols. The method may include additional, fewer or alternate actions, including those discussed elsewhere herein.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an example screen shot or user interface of a base game result of an electronic game in a base game mode that may be provided by the EGMs shown in FIGS. 1-3 and the mobile devices shown in FIGS. 2B and 2C.

FIG. 5 is an example screen shot or user interface of another base game result of the electronic game of FIG. 4 when in the base game mode.

FIG. 6 is an example screen shot or user interface of a feature game initiated in one of two reel areas of the electronic game of FIGS. 4 and 5 when in a feature game mode.

FIG. 7 is an example screen shot or user interface of another base game result of the electronic game of FIGS. 4-6, generated after the feature game of FIG. 6 has concluded and the electronic game has returned to the base game mode.

FIG. 8 is an example screen shot or user interface of a play of a feature game initiated in each of the two reel areas of the electronic game of FIGS. 4-7 when in the feature game mode.

FIG. 9 is an example screen shot or user interface of the play of the feature game of FIG. 8, at the conclusion of the feature game with each of the two reel areas completely populated with feature symbols.

FIG. 10 is an example method of providing an electronic game in accordance with the present disclosure.

Corresponding reference numerals used throughout the drawings indicate corresponding elements.

### DETAILED DESCRIPTION

In conventional reel-based games, in a given game outcome, a gaming device may display one or more feature symbols or objects in a viewable portion of a set of reels (e.g., within a play area) along with other base symbols or objects. Feature symbols that appear in the play area may trigger a feature game (e.g., a bonus game or a special mode of game play). The feature game may be triggered based upon a single feature symbol or a threshold count of feature symbols (e.g., six feature symbols) appearing within the play area in a result of a base reel game. In some instances, the gaming device also generates additional feature symbols that are added to the play area in a given result of the feature game. At the conclusion of the feature game, an award value associated with the feature symbols displayed in the play area may be generated and provided to a player. The variability and flexibility in providing awards and displaying supplemental visual effects in conventional reel-based games remain limited, however. Furthermore, in conventional gaming, the feature symbols that are included in the result of the base reel game are typically included in the evaluation of the base game result. This requires additional computational resources because each instance of a feature symbol appearing in the result of the base game requires controlling the rate at which the feature symbols trigger the feature game as well as the rate at which the feature symbols create winning symbols combinations in the result of the base game. As a result, the number of instances of the feature symbols during base game play and/or any credit value awarded on the feature symbols may be limited to control return-to-player and payout volatility. Consequently, the variability and flexibility with which the feature symbols may be used is limited. A need exists to address these limitations to facilitate increased variability in the game play while reducing or maintaining the computational resources used and while doing so during game play.

Example implementations described herein provide systems and methods for an electronic game that include multiple reel areas in which a plurality of symbols are displayed in a result of a base game. Feature symbols that are displayed in either reel area provide opportunities to trigger a feature game. The feature symbols also act as blocking symbols for the purposes of evaluating the outcome of the base game, such that any symbol position that includes a feature symbol in either reel area is precluded from forming part of a winning symbol combination under any defined win condition. The feature symbols in each reel area are maintained, or persist, in their respective symbol positions between plays of the base game until the feature game is initiated in the respective reel area. Once the feature game is initiated, the play of the feature game proceeds in the respective reel area(s) in which it was triggered, and the feature symbols are removed from the reel area(s) after play of the feature game when the game returns to a base game mode. If the feature game is triggered in only one reel area, a visual indication that the feature game is not activated in the other reel area is displayed, and the feature symbols of the other reel area persist for subsequent plays of the base game.

The example implementations described herein provide electronic gaming systems and methods that solve various technical problems in the realm of electronic gaming. For example, the ability to provide an electronic game as described herein, which includes blocking feature symbols that remove symbol positions from forming part of a winning combination of symbol positions may require complex computations to continually monitor the active symbol positions and control the base game outcomes to achieve the desired return-to-player and payout rate. Existing gaming devices may not be configured with the resources to perform these computations in an effective and/or efficient manner while also managing payout volatility and RTP. The systems and methods described herein include the provision of a user interface with two reel areas that are played in conjunction with one another to provide a result of the base game, which enables the blocking feature symbols to be used while maintaining or reducing the computational resources required to ensure all objectives of the electronic game are met. Furthermore, as the reel areas are played in conjunction but operated independently, both during the base game and any feature game that may be triggered in one or both reel areas, a user interface providing the electronic game must be configured to display information and visual feedback related to the feature symbols and the reel areas and their status during game play, and to do so within a limited display area. The systems and methods described herein include display of visual indications that clearly indicate the status of symbol positions in the play area and visually inform progress of the feature game.

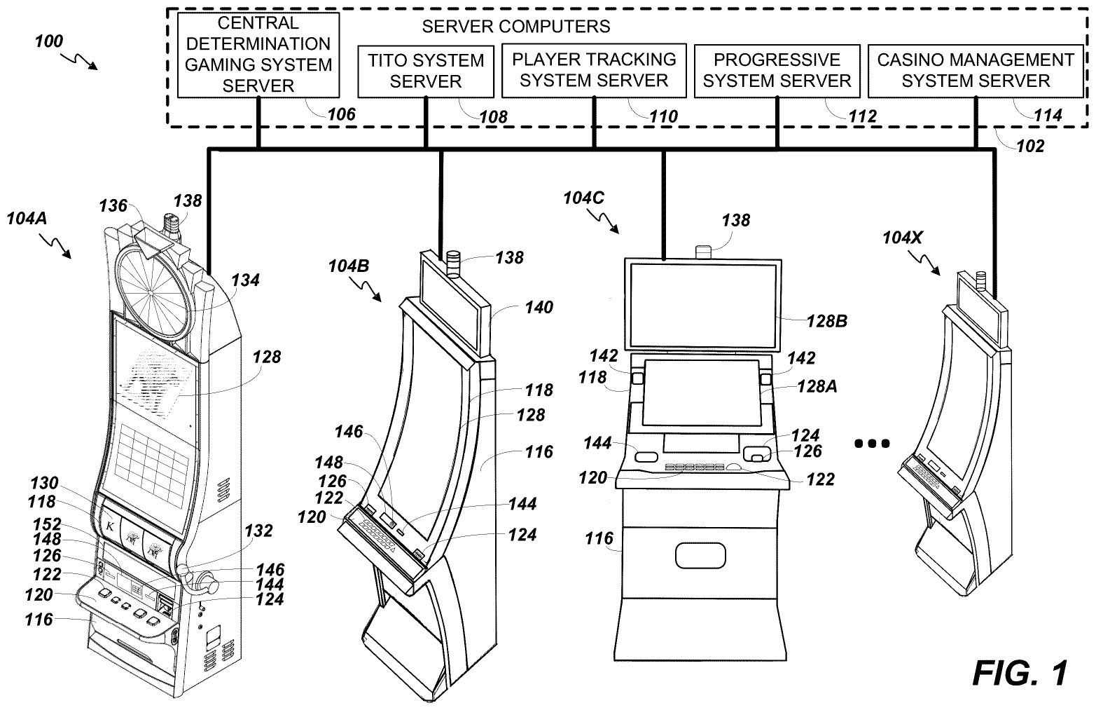

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

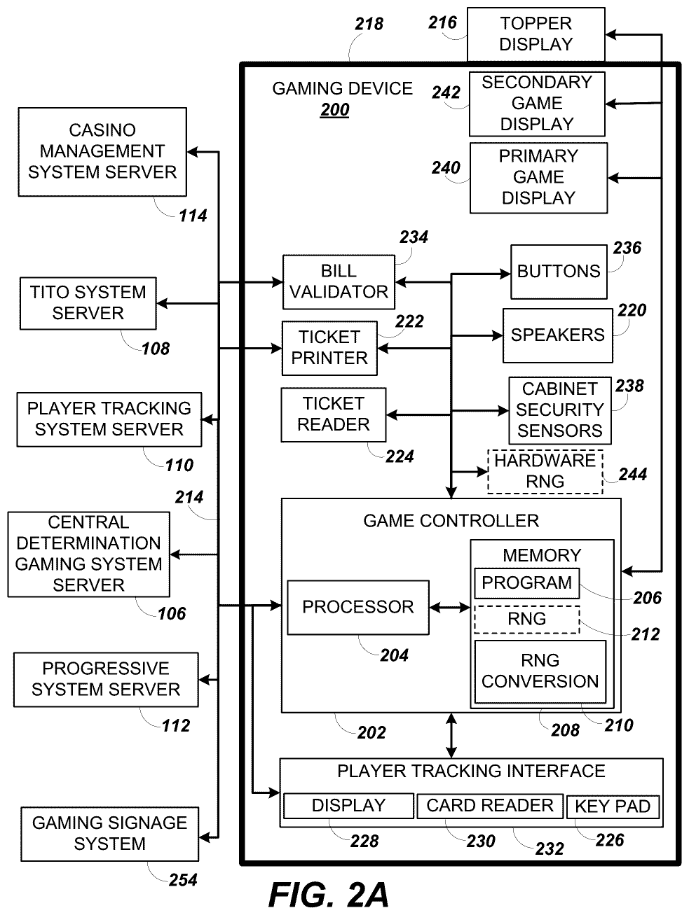

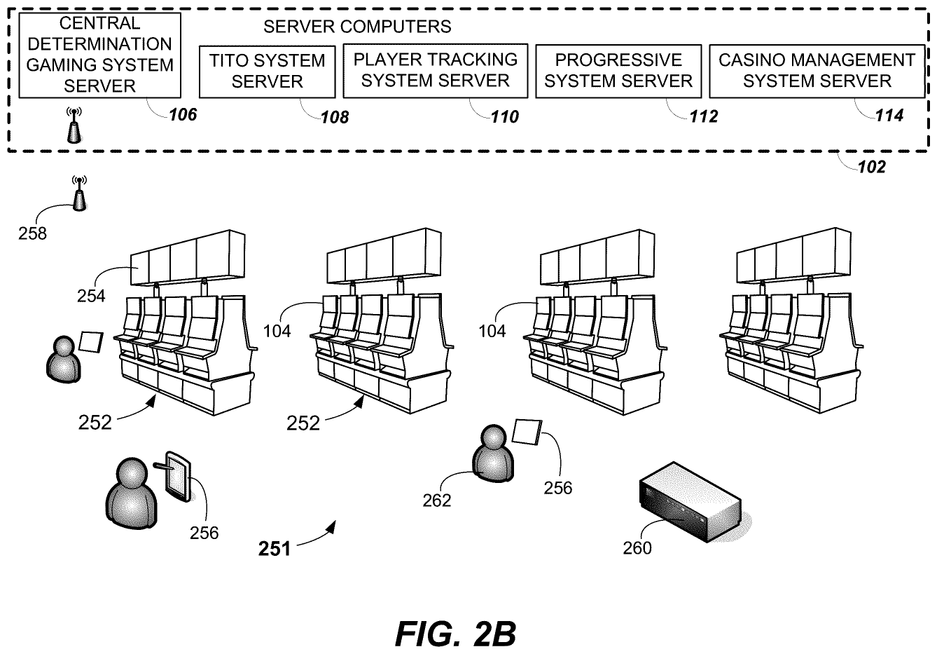

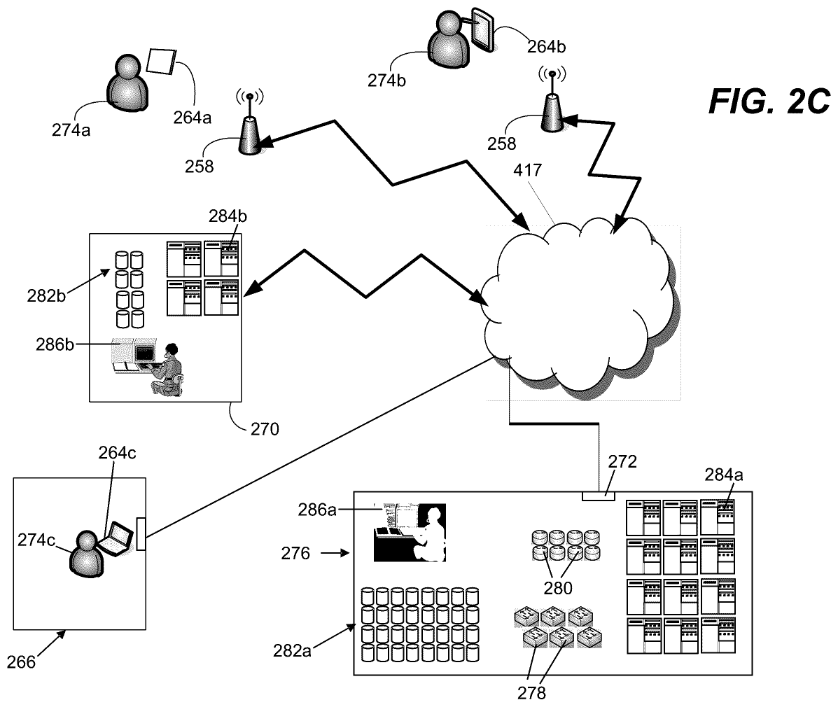

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204: (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games: newly introduced game elements such as extra reels, new symbols, or new cards: stop positions for dynamic game elements such as spinning reels, spinning wheels, or shifting reels: or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by AristocratR Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

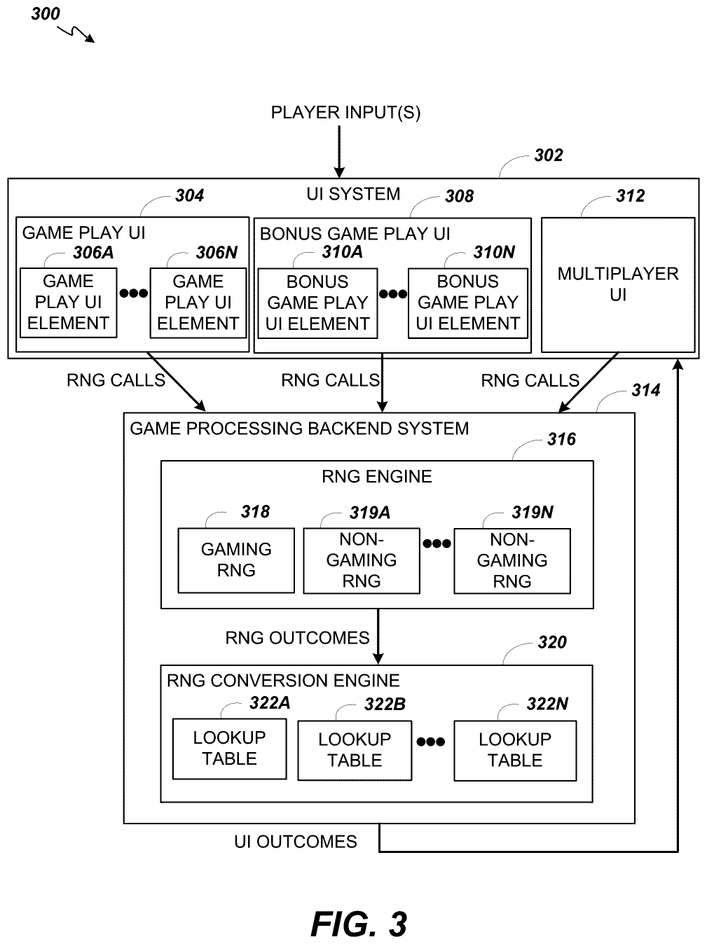

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

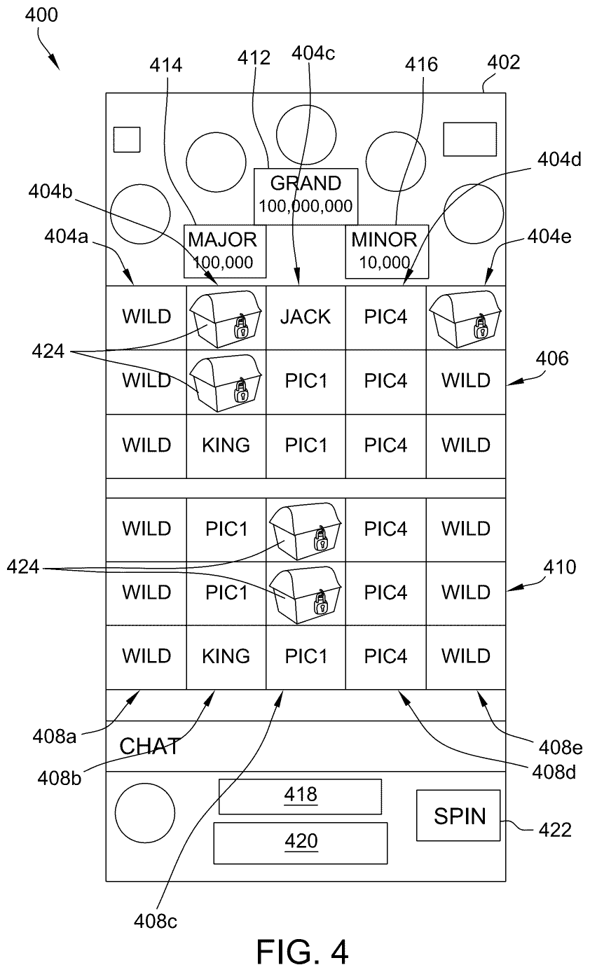

FIG. 4 is an example screen shot 400 of base game play of an electronic game that may be provided by a gaming device, such as the EGMs 104A-104X, 200 shown in FIGS. 1-3 and the mobile devices 256, 264 shown in FIGS. 2B and 2C, for example. The gaming device may perform operations to control gameplay and cause display of the described electronic game via a game controller (e.g., game controller 202 shown in FIG. 2A) that may include one or more processors (e.g., processors 204 shown in FIG. 2A) operatively coupled to a memory (e.g., memory 208 shown in FIG. 2A).

In the illustrated embodiment, the base game is a slot-style reel game and is initiated on the gaming device. A player may fund the electronic game to initiate a play of the base game via bill validator 234 and/or ticket reader 224. Once funded, the base game is presented via a graphical user interface 402 (e.g., on one or more display devices of gaming device 104A-104X, 256, 264). The user interface 402 may be a game play UI 304 provided by the UI system 302. The user interface 402 displays a first play area 406, also referred to as a first base game play area or a first reel area, and a second play area 410, also referred to as a second base game play area or a second reel area. The first play area 406 and second play area 410 are located adjacent to each other on the user interface 402. In the example implementation, the first play area 406 is located vertically above the second play area 410 on the user interface 402. In other implementations, the first play area 406 may be located below the second play area 410, or the first play area 406 and the second play area 410 may be located in side-by-side arrangement. In the example implementation, two play areas 406 and 410 are depicted, however more than two play areas or reel areas may be utilized in other implementations.

The base game may be played on several displays (e.g., a primary display and a secondary display of the gaming device). However, in other implementations, the base game may be played on a single display and/or on more than two displays. In the example base game, as shown in FIG. 4, the first play area 406 and the second play area 410 are each located on the user interface 402 presented on a single display. The user interface 402 may be presented across multiple displays, with each display including one of the play areas 406 and 410. Each display may include the user interface 402 with both play areas 406 and 410. In some implementations, one or both of the play areas 406 and 410 may appear in other locations on the user interface 402 and/or on other displays, such as, for example, a secondary display, a button deck display, and the like.

The base game utilizes first reels 404a-404e that are displayed in the first play area 406 and second reels 408a-408e that are displayed in the second play area 410. The first play area 406 includes an array of symbol display positions, or symbol positions, for display of symbols contained on reel strips associated with the first reels 404a-404e. The second play area 410 includes an array of symbol display positions, or symbol positions, for display of symbols contained on reel strips associated with the second reels 408a-408e. The reel strips associated with the first reels 404a-404e and the second reels 408a-408e are stored in the memory 208 of the gaming device. In the example implementation, a common set of reel strips are used for each of the first reels 404a-404e and the second reels 408a-408e. In other implementations, different reel strips may be used for the first reels 404a-404e and the second reels 408a-408e.

The first reels 404a-404e and the second reels 408a-408e may be physical reels and/or virtual reels. As used herein, physical reels are mechanical in nature and may be physically rotated during gameplay. In contrast, virtual reels are rendered or visually created by game controller 202 on the user interface 402, such as in the first play area 406 and in the second play area 410, and are merely animated to give the appearance of being spun. The first reels 404a-404e and the second reels 408a-408e of the example base game each include five reels. In other examples, any number of reels may be utilized in the base game. For example, the number of reels may range from one reel to five or more reels in number. In some implementations, the number of reels included in the first reels 404a-404e may be different from the number of reels included in the second reels 408a-408e.

The first play area 406 and the second play area 410 may each include any suitable number of symbol display positions for display of symbols contained on the reel strips associated with the first reels 404a-404e and the second reels 408a-408e, respectively. In various implementations, the first play area 406 and the second play area 410 are reel matrices having m columns and n rows, where m and n are integers greater than zero. In the example embodiment, each of the first play area 406 and the second play area 410 is a 3×5 reel matrix for respective display of symbols contained on the first reels 404a-404e and the second reels 408a-408e (i.e., a reel matrix having three rows and five columns). As a result, in the example embodiment, fifteen symbol positions are displayed in the first play area 406, three symbol positions for each reel 404a-404e, and fifteen symbol positions are displayed in the second play area 410, three symbol positions for each reel 408a-408e. In other implementations, the first play area 406 and the second play area 410 may be any size reel matrix (e.g., 2×2, 3×3, 4×4, 10×10, etc.), and a number of symbol positions in the reel matrix may vary depending upon a number n of rows and a number of m columns displayed. The first play area 406 may have a different number of symbol positions than the second play area 410. In some implementations, the reel matrix may be replaced by one or more mechanical reels, and the implementations described herein work equally well with mechanical reels as with the reel matrix. Each row of the reel matrix may be designated by a row number (e.g., “1,” “2,” “3,” etc.). Each column of the reel matrix may be designated by a column letter (e.g., “A,” “B,” “C,” “D,” “E,” etc.). Each symbol position of the reel matrix may therefore be designated by a symbol position identifier comprising a row number (e.g., “1,” “2,” “3,” etc.) and a column letter (e.g., “A,” “B,” “C,” “D,” “E,” etc.). For example, the upper-left-most symbol position, occurring at the intersection of row 1 and column A, may be designated by the symbol position identifier “1A.”

During play of the base game in a base game mode, symbols may be selected from symbol sets contained in the reel strips associated with the first reels 404a-404e and the second reels 408a-408e. The selected symbols are displayed in the symbol positions of each column of symbols within the first play area 406 and within the second play area 410. As shown in FIG. 4, in the example embodiment, the reel strips of the first reels 404a-404e and the second reels 408a-408e include a plurality of symbols arranged in a vertical column. A number of symbols of each reel strip, corresponding to the number of rows of the reel matrices of the first play area 406 and the second play area 410, is displayed in a column of symbol positions within the reel matrices during play of the base game. To display symbols from a reel strip within the reel matrices during base game play, a game controller and/or processor of the gaming device (e.g., game controller 202 and/or processor 204) may simulate rotation or spinning of each of the first reels 404a-404e within a respective column of the first play area 406 and each of the second reels 408a-408e within a respective column of the second play area 410. Mechanical reels having physical reel strips may be used as well. When a respective reel strip is simulated to halt or stop within an associated column, one or more symbols may be displayed from the reel strip in the symbol positions of the column. In some implementations, a separate reel, i.e., an independent reel, may be utilized for each symbol position of the first play area 406 and/or the second play area 410 during game play. That is, in these implementations, during a play of the base game, an independent reel may spin and stop in each symbol position in one or both of the first play area 406 and the second play area 410, and when stopped, one symbol may be displayed from the reel strip of the independent reel within the respective symbol position.

The symbols displayed after spinning and stopping each of the first reels 404a-404e in the first play area 406 and each of the second reels 408a-408e in the second play area 410 may be referred to herein as an “outcome” or a “result” of the base game. More broadly, an “outcome” or a “result” of a reel game, such as the base game shown in FIG. 4, refers to the symbols displayed in a reel matrix (e.g., of the first play area 406 and of the second play area 410) after reels are spun and stopped. A rotation and stopping of a plurality of reels (also referred to as a “spin and stop sequence”) may be simulated by the game controller 202 and/or the processor 204 within the first play area 406 and the second play area 410 to cause a result of the base game, including a plurality of symbols, to be displayed from the first reels 404a-404e within the first play area 406 and from the second reels 408a-408e within the second play area 410.

The symbols displayed in first play area 406 and the second play area 410 in an outcome or result of the base game may be randomly selected or determined based on one or more RNG outcomes. To generate an RNG outcome, a random number is generated, and a lookup operation is performed for the random number in a lookup table (e.g., one or more of lookup tables 322A . . . 322N in FIG. 3), to map the random number to an outcome that corresponds to a result of the base game. The RNG outcome may be generated by the RNG engine 316 which uses the gaming RNG 318 to generate one or more random numbers, which are passed to the RNG conversion engine 320, and the RNG conversion engine 320, using one or more of the random number(s) and one or more of the lookup tables 322A . . . 322N, determines an RNG outcome. The game controller 202 may select the symbols for display in the first play area 406 and the second play area 410 by determining stopping positions for each of the first reels 404a-404e and each of the second reels 408a-408e based on one or more RNG outcomes. The stopping positions of the reels 404a-404e and 408a-408e determined based on the RNG outcome(s) correspond to the symbols of the associated reel strips that are displayed within the symbol positions of the play areas 406 and 410.

As shown in FIG. 4, the outcome of the base game includes a combination of symbols displayed in the first play area 406 that is different from the combination of symbols displayed in the second play area 410. The first reels 404a-404e and the second reels 408a-408e are independently operable such that different symbol combinations may be displayed in the first and second play areas 406 and 410. That is, the stopping positions of the first reels 404a-404e may be determined independently from the stopping positions of the second reels 408a-408e, or the symbols contained on the reel strips associated with the first reels 404a-404e may be selected for display in the first play area 406 independently from the symbols contained on the reel strips associated with the second reels 408a-408e selected for display in the second play area 410. For example, in some implementations, the outcome of the base game may be determined based on a first RNG outcome that determines the stopping positions of the first reels 404a-404e, corresponding to the combination of symbols displayed in the first play area 406, and a second RNG outcome that determines the stopping positions of the second reels 408a-408e, corresponding to the combination of symbols displayed in the second play area 406. As described above, the reel strips associated with the first reels 404a-404e may be the same or different from the reel strips associated with the second reels 408a-408e. In other implementations, a single RNG outcome may determine the stopping positions for each of the first reels 404a-404e and each of the second reels 408a-408e, and thus determines the combination of symbols displayed in the first play area 406 and the combination of symbols displayed in the second play area 410.

The symbols (and/or combinations of symbols) displayed in the result of the base game may be associated with winning and/or losing base game outcomes and/or awards. After display of the result of the base game, any win conditions can be detected and any win amounts can be awarded to the player (e.g., credited to the player's credit balance). In some examples, win conditions may be defined as pay lines (also called win lines) across at least a portion of the reel matrix of the first play area 406 and the second play area 410. For a round of play of the base game, when a certain combination of symbols appears along a pay line, a win amount corresponding to that combination of symbols and that pay line may be awarded. Win amounts can vary according to the combination of symbols and according to the particular pay line along which the combination of symbols appears. Win amounts are typically determined according to a pay table, where the pay table comprehends the various combinations of symbols and pay lines that may occur (i.e., the win conditions). The win amount for a round of play may be a fraction of an amount wagered for that round of play for certain win conditions. For other win conditions, the win amount may be much larger than the amount wagered. The number of pay lines and base credit cost to play may vary and depends on the implementation of the base game.

Instead of evaluating win conditions on pay lines across reels in a play area, an award can be determined according to a “ways” approach. For example, symbols displayed at symbol display positions within one of the columns of the first play area 406 and the second play area 410 can be used to form symbol combinations (one symbol per reel in a combination) with the symbols displayed at designated symbol display positions of each of the other columns of the respective play area 406 or 410. For example, for the first play area 406 in which there are five reels 404a-404e and three symbol display positions for each reel, each possible path through the symbol display position(s) of the respective reels may provide a way to win. Similarly, for the second play area 410 in which there are five reels 408a-408e and three symbol display positions for each reel, each possible path through the symbol display position(s) of the respective reels may provide a way to win. As a result, the total number of ways to win in each play area 406 and 410 is determined by multiplying the number of active display position(s) of each reel 404a-404e and each reel 408a-408e, where the active display position(s) for a reel are all display positions in the play area. As a result, for five reels and fifteen display positions, there are 35-243 ways to win for each play area 406 and 410.

In the example implementation, the game controller 202 (e.g., via the processor 204) evaluates the base game outcome in the first play area 406 and in the second play area 410 using the same approach (e.g., pay lines and/or ways). That is, the win conditions defined for the combination of symbols displayed in the first play area 406 are the same as the win conditions defined for the combination of symbols displayed in the second play area 410. In other implementations, the win conditions defined for the combination of symbols displayed in the first play area 406 may be different from the win conditions defined for the combination of symbols displayed in the second play area 410. For example, win conditions for the first play area 406 may be defined as pay lines across the first reels 404a-404e and win conditions for the second play area 410 may be defined according to the ways approach, or vice versa.

The user interface 402 may also display additional graphics associated with the base game and/or the electronic game. As shown in FIG. 4, the user interface 402 includes, in addition to the first play area 406 and the second play area 410, three jackpot meters 412-416, including a grand jackpot meter 412, a major jackpot meter 414, and a minor jackpot meter 416. In some examples, there may be different jackpot meters and/or more or fewer than three jackpot meters provided by the user interface 402. For example, a mini jackpot meter (not shown) may also be included on the user interface 402.

The user interface 402 may, in some implementations, also provide a metamorphical graphical element (not shown), or metamorphic, that transforms (e.g., by animation provided on the user interface 402) to visually indicate various features of the base game that may be triggered during base game play. For example, upon triggering of a feature game, a metamorphic on the user interface 402 may transform from an initial state to an active state to visually indicate that a feature game has been triggered. Any types of metamorphics, objects, symbols, or other graphic elements may be used and provided on the user interface 402. In some implementations, a first metamorphic or set of metamorphics associated with the first play area 406 and a second metamorphic or set of metamorphics associated with the second play area 410 may be include on the user interface 402.

The user interface 402 also provides a credit meter 418 indicating a credit balance of a player of the electronic game, a bet meter 420, and an input button 422 (e.g., a SPIN button) that may be selected to initiate a play of the base game when in the base game mode. The elements provided by the user interface 402 are by way of example only, and may be displayed on alternative displays such as those described elsewhere herein. The user interface 402 may also provide additional graphics other than those illustrated and described.

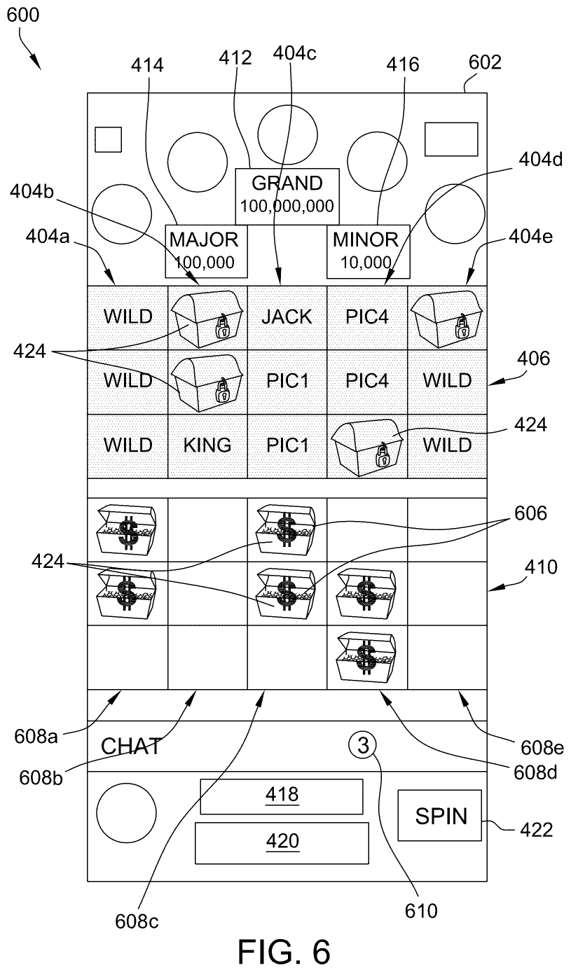

The screenshot 400 shown in FIG. 4 illustrates the result of a play of the base game when in the base game mode. In the example embodiment, the base game uses virtual reel strips for the first reels 404a-404e and the second reels 408a-408e. The reel strips include various basic symbols (e.g., “A”, “K”, “Q”, “J”, “10”, “9”, picture symbols), as well as feature game symbols (or “feature symbols”) 424. Here, the feature symbols 424 may be cash on reel (COR) symbols or “what you see is what you get” (WYSIWYG) symbols, which correspond to credit values awarded for each feature symbol 424. The credit values for each feature symbol 424 may be awarded upon conclusion of a feature game, such as the feature game described below with reference to FIGS. 6, 8, and 9.

The credit values corresponding to each feature symbol 424 that is displayed in the base game outcome may be randomly determined by the game controller 202 (e.g., via the processor 204) based on an RNG outcome mapped to one or more tables of credit values stored in the memory 208. In some embodiments, the credit values corresponding to the feature symbols 424 displayed in the first play area 406 in the base game outcome are randomly selected from the same table of credit values used to determine the credit values corresponding to feature symbols 424 displayed in the second play area 410 in the base game outcome. In other implementations, different credit tables may be used for the feature symbols 424 in the first play area 406 and the second play area 410.

In the example implementation, each feature symbol 424 that is displayed in the base game outcome is presented without a corresponding prize identifier. That is, as shown in FIG. 4, when the feature symbols 424 are displayed in the first play area 406 and the second play area 410 in the base game outcome, the corresponding credit values are not indicated on the user interface 402. As described below, the feature symbols 424 are populated with prize identifiers 606 (FIGS. 6, 8, and 9) when the feature game is triggered and initiated. The credit values may be determined immediately upon display of the feature symbols 424 in the base game outcome, or the credit values may be determined upon initiation of the feature game. In other implementations, the feature symbols 424 may include prize identifiers immediately upon display in the base game outcome. The prize identifiers (e.g., the prize identifiers 606) displayed on the feature symbols 424 visually indicate an award value associated with the corresponding feature symbol. The prize identifiers may be numerical values (e.g., in credits), jackpot identifiers (e.g., mini, minor, major, grand, or the like), or some other prize identifier.

During base game play, the feature symbols 424 may be treated as “blocking” symbols for purposes of evaluating the result of the base game during award determination. That is, the symbol positions of the first play area 406 and the second play area 410 that include the feature symbols 424 are blocked by the feature symbols and, for the purposes of computing the base game award, are precluded from forming a winning symbol combination with the other symbol positions of the play area 406 and 410 that do not include a feature symbol 424. To illustrate, if win conditions in the play areas 406 and 410 are defined by pay lines across the reels 404a-404e and 408a-408e, the feature symbols 424 act to block the ability for a winning pay line to be formed in their respective symbol position. Thus, referring to FIG. 4, in the first play area 406, the top two symbol positions for the second reel 404b and the topmost symbol position for fifth reel 404e are blocked from forming any winning pay lines because feature symbols 424 are displayed in these symbol positions. Similarly, in the second play area 410, the top two symbol positions for the third reel 408c are blocked from forming any winning pay lines. If win conditions in the play areas 406 and 410 are defined under a ways approach, each occurrence of a feature symbol 424 precludes or blocks the corresponding symbol position from being an active display position. As a result, the number of ways to win is reduced for each occurrence of a feature symbol 424. In particular, where the first and second play area 406 and 410 may begin with 35=243 ways to win, for five reels and fifteen display positions, this number of ways to win is reduced each time a feature symbol 424 appears. Referring to FIG. 4, the number of ways to win in the first play area 406 is reduced to 3×1×3×3×2=54 ways to win due to the two feature symbols 424 appearing in the second reel 404b and feature symbol 424 appearing in the fifth reel 404e. The number of ways to win in the second play area 410 is reduced to 3×3×1×3×3-81 ways to win due to the two feature symbols 424 appearing in the third reel 408c.

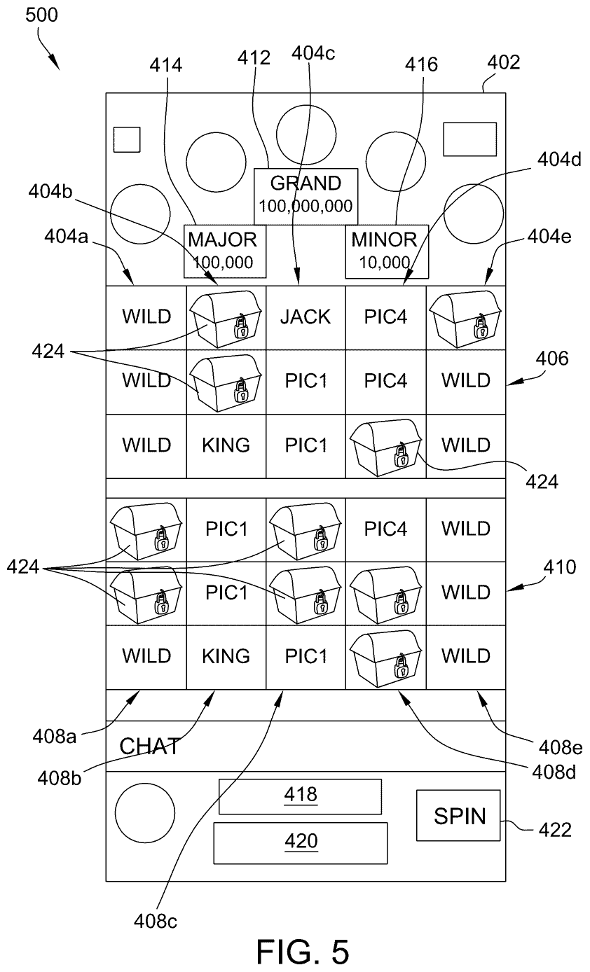

When a blocking feature symbol 424 appears in the base game outcome, the feature symbol 424 is maintained, or persists, in the respective symbol position for subsequent plays of the base game. FIG. 5 is an example screen shot 500 of an outcome of a subsequent play of the base game when in the base game mode, after the outcome shown in FIG. 4. The sequence between FIGS. 4 and 5 shows that the feature symbols 424 that appeared in the base game outcome of FIG. 4 persist and are included in the same symbol positions in the play area 406 and 410 in the base game outcome of FIG. 5. The feature symbols 424 may persist in the respective symbol positions for each play of the base game. As additional feature symbols 424 appear in subsequent base game outcomes, these additional feature symbols 424 likewise persist throughout base game play. To illustrate, in the base game outcome of FIG. 5, the additional feature symbol 424 appearing in the bottommost symbol position of the fourth reel 404d of the first play area 406 persists for subsequent plays of the base game. Similarly, the additional feature symbols 424 appearing in the first reel 408a and fourth reel 408d of the second play area 408 persists for subsequent plays of the base game.

The feature symbols 424 may be provided with a graphic effect to visually indicate the function of the feature symbols during base game play. In particular, the user interface 402 may provide a visual indication that the feature symbols 424 are blocking symbols that persist throughout plays of the base game, and the respective symbol position that is populated with the feature symbol 424 is not included in the evaluation of the base game outcome for award determination. In the example implementation, the feature symbols 424 are locked treasure chest symbols to visually indicate the blocking and persistent function of the feature symbols 424. As described above, the feature symbols 424 are also not provided with a prize identifier when the feature symbols appear in the base game outcome. This visually indicates that the credit values associated with the feature symbols 424 have not been “unlocked”.

Still referring to FIGS. 4 and 5, the feature symbols 424 that appear during the base game outcome provide a chance to trigger the feature game. The feature game may be triggered for the first play area 406 and not the second play area 410, the second play area 410 and not the first play area 406, or both the first play area 406 and the second play area 410. In the example implementation, the game controller 202 and/or processor 204 determines whether a number of feature symbols 424 that appear in the first play area 406 and/or the second play area 410 meets or exceeds a minimum number of feature symbols to trigger the feature game in the respective play area. The minimum number of feature symbols to trigger the feature game in each play area 406 and 410 may be predefined or preselected for the base game. In the example implementation, the triggering number of feature symbols 424 for the feature game in each of the play areas 406 and 410 is six feature symbols 424. In various examples, the triggering number of feature symbols 424 may be three, four, five, six, or more than six feature symbols 424. The triggering number of feature symbols 424 for the first play area 406 may be different than the triggering number of feature symbols 424 for the second play are 410. The triggering number of feature symbols 424 for the play areas 406 and 410 may vary between plays of the base game, and may be defined or determined based on a bet level wagered. In some embodiments, when the triggering number of feature symbols 424 appear in either or both play areas 406 and 410, the game controller 202 and/or processor 204 may determine that this automatically triggers the feature game and the feature game is subsequently initiated in the first play area 406 and/or the second play area 410. In other embodiments, when the triggering number of feature symbols 424 appear in either or both play areas 406 and 410, the game controller 202 and/or processor 204 may then generate a random determination to determine whether the feature game is triggered in the first play area 406 and/or the second play area 410.

In some implementations, the appearance of one or more feature symbols 424 may provide a chance to trigger a feature game of the electronic game in the first play area 406 and/or the second play area 410. For example, the game controller 202 and/or processor 204 may provide a chance for triggering the feature game whenever one or more feature symbols 424 appear in the first play area 406 and/or the second play area 410. In some embodiments, a single chance may be provided to trigger the feature game in the first play area 406 in response to feature symbols 424 appearing therein and a single chance may be provided to trigger the feature game in the second play area 410 in response to feature symbols 424 appearing therein. To illustrate, in the outcome shown in FIG. 5, a single chance would be provided to trigger the feature game in the first play area 406 for the four feature symbols 424 that appear therein, and a single chance would be provided to trigger the feature game in the second play area 410 for the six feature symbols 424 that appear therein. In other embodiments, the game controller 202 and/or processor 204 may provide a chance to trigger the feature game in the play areas 406 and 410 for each feature symbol 424 that appears therein (e.g., four chances to trigger in the first play area 406 and six chances to trigger in the second play area 410 based on the result shown in FIG. 5). Each chance to trigger the feature game based on one or more feature symbols 424 appearing in the play area 406 and 410 may be a random determination by the game controller and/or processor 204, such as a generated RNG outcome as described below.

In some embodiments, the game controller 202 and/or processor 204 generates an RNG outcome for each chance to trigger the feature game to determine whether the feature game is triggered in one or both play areas 406 and 410. That is, the appearance of one or more feature symbols 424 in either play area 406 or 410 may trigger the game controller 202 and/or processor 204 to generate an RNG outcome that determines/indicates whether or not the feature game activates in that play area. The number of generated RNG outcomes corresponds to the number of chances triggered by the appearance of one or more feature symbols 424 in a play area 406 or 410. As described above, in some embodiments, a single chance for triggering the feature game may be provided whenever one or more feature symbols 424 appear in a play area 406 or 410, or a triggering number of feature symbols 424 appear. In these embodiments, the game controller 202 and/or processor 204 may generate a single RNG outcome when one or more feature symbols 424 appear in a play area 406 or 410, or when a triggering number of feature symbols 424 meeting or exceeding the minimum number appears. In other embodiments, a single chance for triggering the feature game may be provided for each of the feature symbols 424 appearing in a play area 406 or 410. That is, in these embodiments, the game controller 202 and/or processor 204 may generate six RNG outcomes when six feature symbols 408 appear in a play area 406 or 410. For each generated RNG outcome, the weights (e.g., the odds) may be determined and fixed, or may be changed based on previous determinations. For example, the odds may increase with every determination of not triggering the feature game over a prescribed play period (e.g., over a number of plays of the base game until a player cashes out, or another defined play period) until a maximum limit is reached. After the feature game is triggered, the odds may be reset to a starting value. The odds for triggering the feature game in each play area 406 and 410 may be the same or different.

The base game outcome of FIG. 5 is an example where the feature game is triggered in the second play area 410 and not the first play area 406. In particular, the triggering number of feature symbols 424 (six total) appear in the second play area 410, while only four feature symbols 424 appear in the first play area 406. The game controller 202 and/or processor 204 then initiates the feature game in the second play area 410, but not the first play area 406.

FIG. 6 is an example screenshot 600 of the feature game initiated in the second play area 410 for a feature game mode triggered in response to the six feature symbols 424 appearing in second play area in the base game outcome shown in FIG. 5. The feature game is presented via a graphical user interface 602 (e.g., on one or more display devices of the gaming device 104A-104X, 256, 264). The user interface 602 may be a bonus play UI 306 provided by the UI system 302. The user interface 602 includes similar display areas as the user interface 402, indicated by corresponding reference numerals. The feature game may be played on several displays (e.g., a primary display and a secondary display of the gaming device). However, in other implementations, the feature game may be played on a single display and/or on more than two displays.

In the feature game mode, the user interface 602 replaces the second reels 408a-408e in the second play area 410 used during the base game mode with feature game reels 608a-608e. The second play area 410 includes the same number of symbol display positions, or symbol positions, for display of symbols from the feature game reels 608a-608e during the feature game mode as during the base game mode. In other implementations, the second play area 410 may have more or fewer symbol display positions during the feature game mode. The feature game reels 608a-608e are associated with feature game reel strips stored in the memory 208. The feature game reel strips may be different from the reel strips used for the second reels 408a-408e during base game play.

During play of the feature game, the feature game reels 608a-608e may spin and stop and display symbols from the associated feature game reel strips in each column of the second play area 410. The game controller 202 may cause display of a spin and stop sequence of the feature game reels 608a-608e, and determine stopping positions of the feature game reels 608a-608e and/or select symbols from the feature game reel strips to be displayed on the stopped reels 608a-608e in the second play area 410 during play of the feature game, as described above for the reels 404a-404e and 408a-408e during base game play. In some implementations, a separate reel, i.e., an independent reel, may be utilized for each symbol position of the second play area 410 during feature game play. That is, in these implementations, during a spin of the feature game, an independent reel may spin and stop in each symbol position in the second play area 410.

In response to triggering the feature game, the game controller 202 and/or processor 204 may cause display of animation on the user interface 402 to visually indicate that the feature game is triggered and in which play area 406 and/or 410 the feature game is triggered. In the example implementation, as shown in FIG. 6, the game controller 202 and/or processor 204 populates each feature symbol 424 in the second play area 410 with a prize identifier 606 upon initiation of the feature game to visually indicate the feature game is triggered in the second play area. The feature symbols 424 in the second play area 410 are also transformed to an “active” state. As shown in FIG. 6, upon initiation of the feature game, the feature symbols 424 in the second play area 410 are transformed from locked treasure chest symbols (FIGS. 4 and 5) to unlocked/open treasure chest symbols (FIG. 6) to visually indicate the that the feature symbols 424 are now “active.” The prize identifiers 606 are illustrated as gold, silver, jewels, etc. contained in the treasure chest feature symbols that are now available in the open chests. Each prize identifier 606 may visually indicate a credit value associated with the feature symbol 424. In various examples, the prize identifiers 606 may be numerical values (e.g., in credits), jackpot identifiers (e.g., mini, minor, major, grand, or the like), or some other prize identifier (e.g., a multiplier value).

In some implementations, metamorphics displayed on the user interface 402 may be transformed on the user interface 602 to visually indicate that the feature game is initiated and in which play area 406 and/or 410. For example, in response to the feature game being triggered in the second play area 410 as shown in FIG. 6, the game controller 202 and/or processor 204 may cause display of animation of a metamorphic associated with the second play area 410, transforming the metamorphic between an initial state or an intermediate state to an active state.

As shown in FIG. 6, the game controller 202 and/or processor 204 also causes display of a visual indication that the feature game is not triggered in the first play area 406 as a result of the base game outcome shown in FIG. 5. The feature symbols 424 in the first play area 406 remain as locked treasure chests to visually indicate that these feature symbols 424 are still inactive. Additionally, a visual overlay (e.g., a darkened screen overlay) is displayed over the first play area 406 to visually distinguish the inactive first play area 406 from the active second play area 410 during feature game play. As the play of the feature game in the second play area 410 continues, the first play area 406 remains inactive and the symbols, including the feature symbols 424, from the outcome of FIG. 5 remain on the first reels 404a-404e. In some implementations, a metamorphic associated with the first play area 406 may be transformed on the user interface 602 to an intermediate state, but not an active state, in response to base game outcome of FIG. 5, to visually indicate that the feature symbols 424 that appeared in the first play area 406 brought the total number of feature symbols 424 in the first play area 406 closer to the triggering number.

When the feature game starts, the triggering number of feature symbols 424 are “held” in their respective symbol positions in the active play area 406 and/or 410. As shown in the sequence of FIGS. 5 and 6, the six feature symbols 424 that trigger the feature game in the second play area 410 are held in their respective positions. The prize identifiers 606 are then populated on these feature symbols 424, which are also transformed to the active state (e.g., transformed to open treasure chest symbols).

The example feature game is a hold-and-spin game with a free spin reset. The feature symbols 424 initially populated in the second play area 410, that is, the triggering number of feature symbols 424 from the base game outcome, are held during each spin of the feature game in their respective symbol positions. The feature game reels 608a-608e are spun and stopped for a designated number of free spins (e.g., three free spins). Additional feature symbols 424 that appear during the free spins feature game are also held in their respective symbol positions. Each additional feature symbol 424 that appears during play of the feature game includes a prize identifier 606. The credit values and/or prize identifiers associated with the additional feature symbols 424 appearing during the feature game may be randomly selected from credit tables or pay tables stored in the memory 208 that are the same or different from the credit or pay tables used to determine the credit values or prize identifiers 606 for the feature symbols 424 appearing during the base game play. For each subsequent spin of the feature game, the feature game reels 608a-608e are respun in the remaining symbol positions of the second play area 410, that is, the symbol positions of the second play area that are not populated with a feature symbol 424.

The number of spins (e.g., three free spins) provided for the feature game may be reset whenever a spin results in the appearance of at least one additional feature symbol 424 in the second play area 410 during the feature game. The user interface 602 may provide a free spin counter 610 (e.g., below the second play area 410 as shown in FIG. 6) and displays a number of free spins remaining in the feature game. If a spin does not result in the appearance of at least one additional feature symbol 424, the free spin counter 610 is reduced (e.g., decremented). FIG. 6 illustrates the free spin counter 610 at three free spins—this would be decremented to two remaining spins if the subsequent free spin did not result in the appearance of at least one additional feature symbol 424. If a spin results in the appearance of at least one additional feature symbol 424, the free spin counter 610 may remain at three free spins or be replenished to three free spins, depending on whether the free spin counter 610 was previously decremented to below three. In this way, the play of the hold-and-spin feature game continues until the free spin counter 610 reaches zero. Additionally and/or alternatively, the feature game initiated in the second play area 410 as shown in FIG. 6 could conclude if all symbol positions in the second play area are populated with feature symbols 424.

In some embodiments, the appearance of at least one additional feature symbol 424 during the hold-and-spin feature game may not automatically trigger a free spin reset, and instead may trigger a chance for the number of free spins to be reset. For example, the appearance of at least one additional feature symbol 424 during the hold-and-spin feature game may trigger the game controller 202 and/or processor 204 to randomly determine, by generating an RNG outcome or RNG outcomes for example, whether the number of free spins are reset.

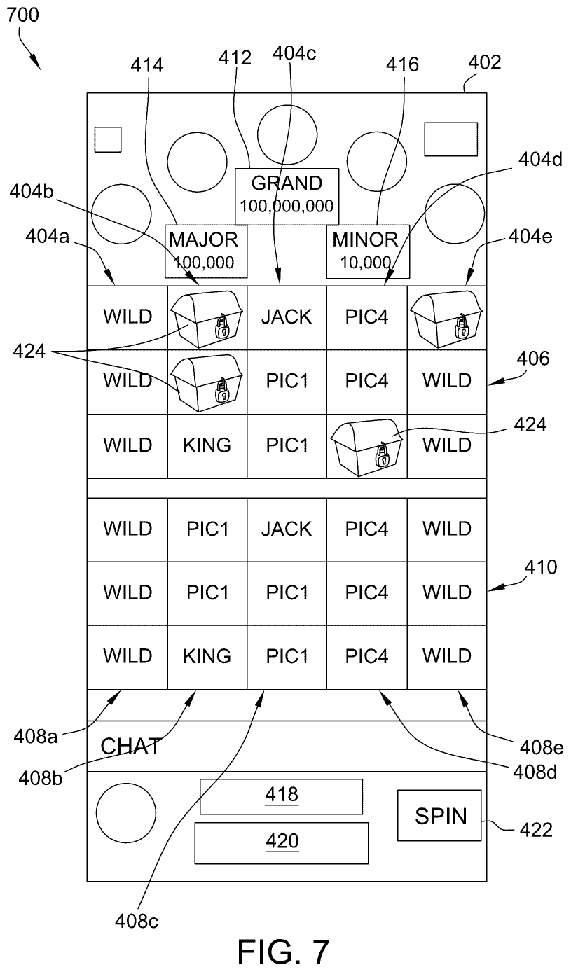

As play of the hold-and-spin feature game of FIG. 6 continues in the second play area 410, the remaining symbol positions in the second play area 410 may continue to fill up with additional feature symbols 424 that appear during a round of the hold-and-spin feature and are held in the second play area 410 during a subsequent round of the hold-and-spin feature game. At some point, the feature game comes to a conclusion, either by the player exhausting their available free spins, or by filling up all of the symbol positions in the second play area 410 with feature symbols 424. Upon conclusion of feature game play, the game controller 202 and/or processor 204 computes a feature game award total and generates the feature game award total. In the example embodiment, the player is awarded all of the values indicated by the prize identifiers 606 respectively appearing on the feature symbols 424 in the second play area 410 at the end of feature game play. The feature symbols 424 in the first play area 406, which is inactive during the feature game in the example of FIG. 6, are not included in the feature game award total at the conclusion of this example play of the feature game. Upon determining the award value(s) to be included in the feature game award total, game controller 202 and/or processor 204 generates the award total and provides the award total to the credit balance of the player or otherwise triggers a payout to the player. At this time, the game controller 202 and/or processor 204 may also compute and generate a base game award total based on the symbols displayed in the first play area 406 and the second play area 410 in the base game outcome (FIG. 5) satisfying the defined win conditions for the play areas 406 and 410. Alternatively, the base game award total may be computed and generated prior to play of the feature game. As described above, the symbol positions populated with the feature symbols 424 are not included in the evaluation of the base game award total. After the play of the feature game, all the feature symbols 424 are removed from the second play area 410 (FIG. 7).

FIG. 7 is a screen shot 700 of another outcome of the base game after play of the feature game shown in FIG. 6. As shown, the feature symbols 424 have been removed from the second play area 410 when the game controller 202 causes the electronic game to return to the base game mode (FIG. 7) from the feature game mode (FIG. 6). The feature symbols 424 in the first play area 406, which was inactive during feature game play of FIG. 6 within the second reel area 410, persist from the outcome shown in FIG. 5, and remain displayed in their respective symbol positions in the first play area 406. Another play of the base game in the base game mode is provided as described above, and feature symbols 424 that appear in either the first play area 406 or the second play area 410 persist and act as blocking symbols for the purposes of base game award evaluation, until a feature game is triggered in the respective play area 406 and 410.

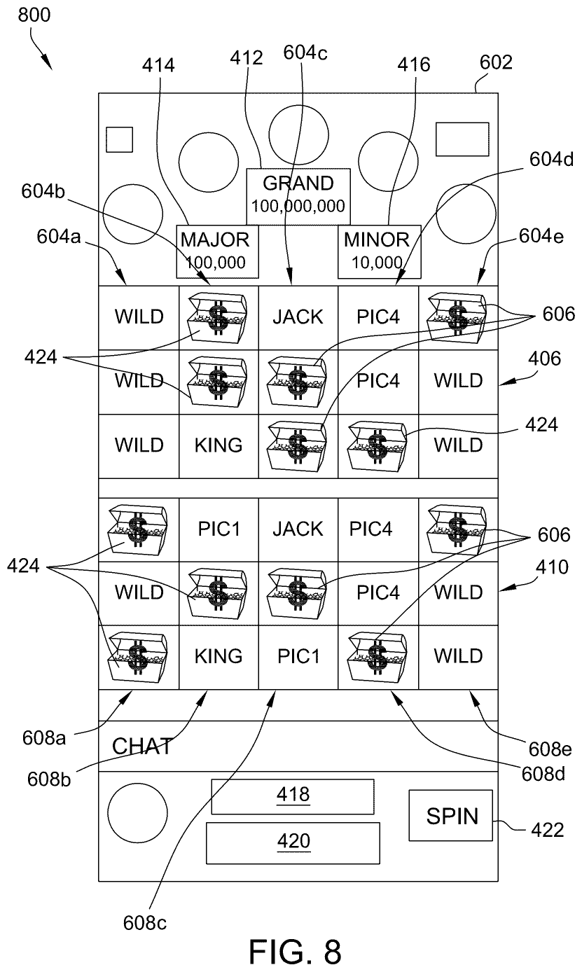

FIG. 8 is an example screen shot 800 of an outcome of a subsequent play of the base game in the base game mode, after the outcome shown in FIG. 7. The sequence between FIGS. 5-8 shows that, over the course of one or more plays of the base game following the base game outcome of FIG. 5, the feature symbols 424 that appeared in the base game outcome of FIG. 5 persist and are included in the same symbol positions in the first play area 406 in the base game outcome of FIG. 8. Additional feature symbols 424 appear in the first play area 406 and second play area 410, bring the total number of feature symbols 424 to six in each play area 406 and 410 which meets the triggering number of feature symbols. The game controller 202 and/or processor 204 determines that the feature game is triggered in both play areas 406 and 410 and initiates the feature game in each play area 406 and 410 as a result.

As shown in FIG. 8, upon initiation of the feature game in each of the play areas 406 and 410, the game controller 202 and/or processor 204 controls the user interface 602 to display visual indications that the feature game is active in each play area. In particular, the game controller 202 and/or processor 204 causes the user interface 602 to populate the feature symbols 424 in each play area 406 and 410 with a corresponding prize identifier 606 and to transform the feature symbols 424 to unlocked/open treasure chest symbols. In some implementations, the game controller 202 and/or processor 204 may cause the user interface 602 to transform metamorphic(s) associated with the first play area 406 and metamorphic(s) associated with the second play area 410 to an active state.

When the feature game is initiated in the first and second play areas 406 and 410, the user interface 602 replaces the first reels 404a-404e in the first play area 406 with feature game reels 604a-604e and the second reels 408a-408e in the second play area 410 with the feature game reels 608a-608e. The first play area 406 and the second play area 410 include the same number of symbol display positions, or symbol positions, for display of symbols from the respective feature game reels 604a-604e and 608a-608e during a play of the feature game as during plays of the base game. In other implementations, the first play area 406 and/or the second play area 410 may have more or fewer symbol display positions during the feature game. The feature game reels 604a-604e and 608a-608e are associated with feature game reel strips stored in the memory 208. The feature game reel strips may be different from the reel strips used for the first reels 404a-404e and the second reels 408a-408e during base game play. The feature game reels 604a-604e and the feature game reels 608a-608e may be associated with a common set of feature game reel strips or different sets of feature game reel strips.

Play of the feature game, which is a hold-and-spin feature game in the example implementation, continues in each of the first play area 406 and the second play area 410 as described above with reference to FIG. 6. The triggering number of feature symbols 424 are “held” in their respective symbol positions in the active play area 406 and/or 410, shown as open treasure chest symbols and populated with the respective prize identifiers 606. The feature symbols 424 initially populated in the play areas 406 and 410 are held during each spin of the feature game in their respective symbol positions for the designated number of free spins (e.g., three free spins). Additional feature symbols 424 that appear in the first play area 406 and/or the second play area 410 during the free spins feature game are also held in their respective symbol positions during the remaining spins of each respective play area 406 and 410 as described above.

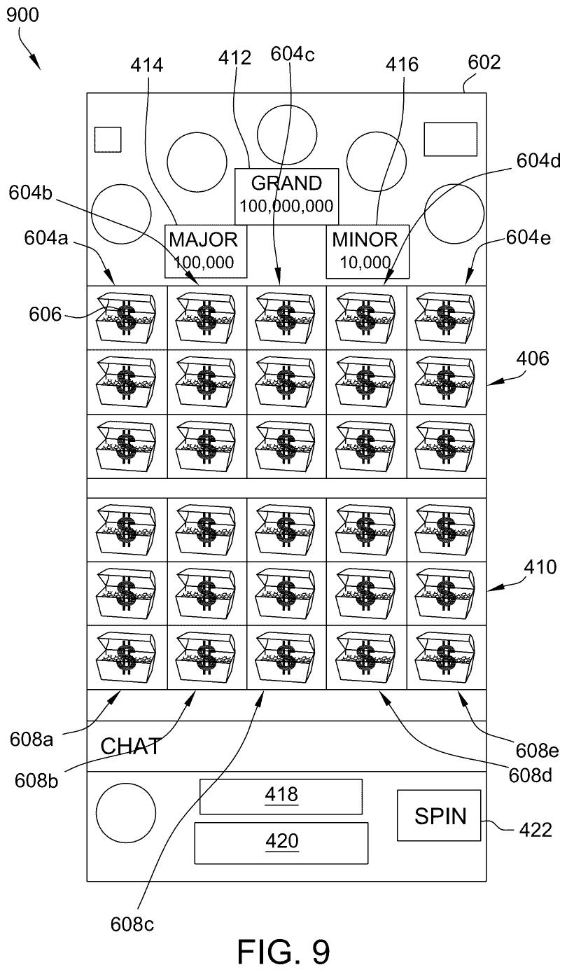

The number of spins provided for the feature game played in the first play area 406 may be the same or different from the number of spins provided for the feature game played in the second play area 410. In the example implementation, the feature game played in each play area 406 and 410 is provided with three free spins. As described above, the number of free spins in either play area 406 or 410 may be reset whenever a spin in the respective play area results in the appearance of at least one additional feature symbol 424. The user interface 602 may provide two free spin counters 610a and 610b, one for each play area 406 and 410, and displays a number of free spins remaining in the feature game for the first play area 406 in the counter 610a and for the second play area 408 in the counter 610b. If a spin in the play area 406 and/or 410 does not result in the appearance of at least one additional feature symbol 424, the respective free spin counter 610a and/or 610b is reduced (e.g., decremented). If a spin results in the appearance of at least one additional feature symbol 424 in the play area 406 and/or 410, the respective free spin counter 610a and/or 610b may remain at three free spins or be replenished to three free spins, depending on whether the respective free spin counter 610a and/or 610b was previously decremented to below three. In this way, the play of the feature game in the first play area 406 continues until the free spin counter 610a reaches zero and the play of the feature game in the second play area 410 continues until the free spin counter 610b reaches zero. Additionally and/or alternatively, the feature game initiated in either play area 406 and/or 410 could conclude if all symbol positions in the respective play area are populated with feature symbols 424 (FIG. 9).

As play of the hold-and-spin feature game of FIG. 8 continues in the first play area 406 and the second play area 410, the remaining symbol positions in the first and second play areas may continue to fill up with additional feature symbols 424 that appear during a round of the hold-and-spin feature and are held in the respective play area during a subsequent round of the hold-and-spin feature game. At some point, the play of the feature game comes to a conclusion, either by the player exhausting their available free spins, or by filling up all of the symbol positions in the first play area 406 and/or second play area 410 with feature symbols 424. FIG. 9 is an example screenshot 900 after one or more spins of the feature game initiated in FIG. 8 in each play area 406 and 410, where the symbol positions of each play area 406 and 410 are fully populated with feature symbols 424, which ends the feature game. In other examples, the play of the feature game may conclude when one of the play areas 406 and 410 is fully filled with feature symbols 424 and the number of available spins is exhausted in the other play area.

Upon conclusion of feature game play, the game controller 202 and/or processor 204 computes a feature game award total and generates the feature game award total. In the example embodiment, the player is awarded all of the values indicated by the prize identifiers 606 respectively appearing on the feature symbols 424 in the first play area 406 and in the second play area 410 at the end of feature game play. After the play of the feature game, all the feature symbols 424 are removed from the first play area 406 and the second play area 410.

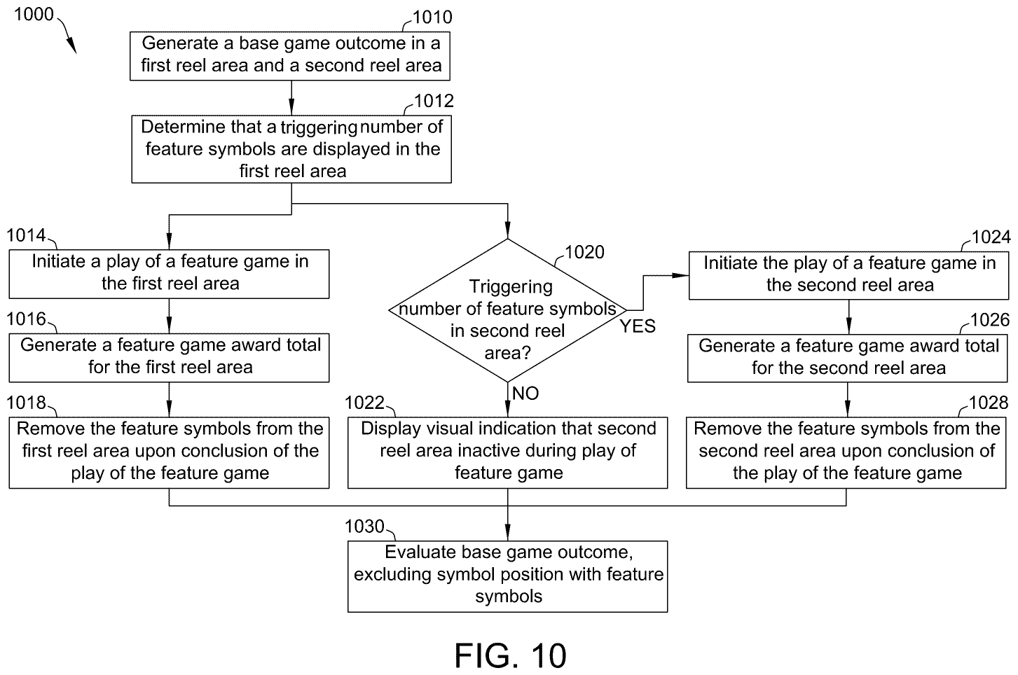

FIG. 10 is an example method 1000 for providing an electronic game that includes a base game (e.g., the base game shown in FIGS. 4, 5, and 7) and a feature game (e.g., the feature game shown in FIGS. 6, 8, and 9). In some embodiments, the electronic game may be provided on a gaming device (e.g., gaming devices 104A-104X in FIG. 1 and/or gaming device 200 and/or the mobile computing devices 256, 264 in FIG. 2). The example method 1000 may be implemented in a server (e.g., server 102) and/or the gaming device (e.g., gaming devices 104A-104X in FIG. 1, and/or gaming device 200 and/or mobile gaming device 256 in FIG. 2). For example, in an electronic gaming device, a game controller (e.g., game controller 202) includes one or more processors 204 operatively coupled to memory 208. The memory 208 can store one or more game programs 206 that provide program instructions and/or data for carrying out various implementations (e.g., game mechanics) that, when executed by the processor 204, cause the processor 204 to perform certain operations to perform the method 1000.

At operation 1010, the gaming device initiates a play of the base game in a base game mode and generates a base game outcome including a plurality of symbols displayed in a first reel area (e.g., the first reel area 406) and a second reel area (e.g., the second reel area 410) on a user interface of a display device (e.g., the user interface 402). The gaming device evaluates the base game outcome in each reel area 406 and 410 to determine whether any feature symbols (e.g., feature symbols 424) are included in any of the symbol positions of the first reel area 406 and the second reel area 410. For a reel area 406 and/or 410 that does not include feature symbols 424, the gaming device computes and generates the base game award total using the pre-defined win conditions for all symbol positions of the reel area. If neither the first reel area 406 nor the second reel area 410 includes feature symbols 424, the base game award total is generated and computed based on all the symbol positions in both reel areas, the award total is paid out to the player, and the play of the base game ends. If the first reel area 406 and/or the second reel area 410 includes one or more feature symbols 424, the symbol positions that include the feature symbols are precluded from forming a winning symbol combination for the base game award. The evaluation of the base game outcome is shown at operation 1030 in FIG. 10—which may be performed before any triggered play of a feature game is initiated or after play of the feature game. The gaming device also determines whether the feature symbols included in the first reel area 406 and/or the second reel area 410 satisfy a trigger condition stored in the memory 208 to initiate a play of a feature game in the respective reel area in a feature game mode. In the example method 1000, the trigger condition to trigger the feature game in the first reel area 406 and/or the second reel area 410 is a triggering number of feature symbols 424 (e.g., six feature symbols) included in the respective reel area in the base game outcome.

In the example method 1000, the gaming device determines, at operation 1012, that a triggering number of feature symbols 424 are displayed in the first reel area 406 in the base game outcome. In response, at operation 1014, the gaming device initiates a play of a feature game within the first reel area 406. The feature game may be the hold-and-spin feature game described above with reference to FIGS. 6, 8, and 9. The hold-and-spin feature game continues with the predefined number of respins, which may result in additional feature symbols 424 being populated in the first reel area 406 and generating a free spin reset. The play of the feature game in the first reel area 406 concludes when either the number of remaining free spins reaches zero or the first reel area is completely populated with feature symbols 424. Upon conclusion of the play of the feature game in the first reel area 406, at operation 1016 the gaming machine computes and generates a feature game award total for the first reel area 406. The feature game award total may be computed based on the credit values associated with the feature symbols 424 (which may be COR symbols or WYSIWYG symbols as described above). At operation 1018, the gaming machine then removes the feature symbols 424 from the first reel area 406, such that the first reel area 406 is depleted of feature symbols for any subsequent play of the base game. The gaming machine may then cause return to the base game mode.

In the example method 1000, at operation 1020, the gaming machine also determines whether a triggering number of feature symbols 424 are displayed in the second reel area 410. If not, at operation 1022, the gaming machine controls the user interface of the display device to display a visual indication that the play of the feature game is not initiated in the second reel area 410. For example, a darkened screen overlay may be displayed over the second reel area 410 at operation 410 during play of the feature game in the first reel area 406. If, at operation 1020, the gaming device determines that a triggering number of feature symbols 424 are displayed in the second reel area 410 in the base game outcome, the gaming device initiates the play of a feature game in the second reel area 410 at operation 1024. The play of the feature game in the second reel area 410 concludes when either the number of remaining free spins reaches zero or the second reel area is completely populated with feature symbols 424. Upon conclusion of the play of the feature game in the second reel area 410, at operation 1026, the gaming machine computes and generates a feature game award total for the second reel area 410. At operation 1028, the gaming machine then removes the feature symbols 424 from the first reel area 406, such that the first reel area 406 is depleted of feature symbols for any subsequent play of the base game. The gaming machine may then cause return to the base game mode.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic gaming machine comprising:
at least one display device configured to display an electronic game that includes a first reel area and a second reel area; and
a game controller configured to execute instructions stored in at least one memory that, when executed, cause the game controller to:
cause display of a plurality of symbols including one or more feature symbols in each of the first and second reel areas as part of a base game when in a base game mode;
determine that the first reel area includes a triggering number of the feature symbols displayed therein for triggering a feature game in a feature game mode;
initiate the feature game within the first reel area;
determine whether the second reel area includes the triggering number of the feature symbols displayed therein;
in response to the second reel area not including the triggering number of the feature symbols, cause display of a visual indication that the second reel area is inactive for the feature game; and
upon conclusion of the feature game:
generate a feature game award; and
cause return to the base game mode including (i) cause the feature symbols to be removed from display in the first reel area, and (ii) cause display of a visual indication that the second reel area is reactivated while maintaining the display of the feature symbols in the second reel area when the second reel area does not include the triggering number of the feature symbols.

2. The electronic gaming machine of claim 1, wherein the instructions, when executed, further cause the game controller to evaluate both the first and second reel areas for a base game award when in the base game mode, wherein symbol positions of the first and second reel areas in which the feature symbols are displayed are precluded from forming a winning symbol combination for the base game award.

3. The electronic gaming machine of claim 1, wherein the instructions, when executed, further cause the game controller to randomly select the plurality of symbols for display in each of the first and second reel areas from a common set of reel strips stored in the at least one memory.

4. The electronic gaming machine of claim 1, wherein the plurality of symbols is a first plurality of symbols, wherein the instructions, when executed, further cause the game controller to cause display of a second plurality of symbols in each of the first and second reel areas after return to the base game mode as part of a second base game, and wherein the second plurality of symbols includes the maintained display of the feature symbols in the second reel area when the first plurality of symbols does not include the triggering number of the feature symbols displayed in the second reel area.

5. The electronic gaming machine of claim 4, wherein the instructions, when executed, further cause the game controller to:
determine that the second reel area includes the triggering number of the feature symbols of the second plurality of symbols displayed therein for triggering a second feature game in the feature game mode;
initiate the second feature game within the second reel area;
determine whether the first reel area includes the triggering number of the feature symbols of the second plurality of symbols displayed therein;
in response to the first reel area not including the triggering number of the feature symbols, cause display of a visual indication that the first reel area is inactive for the second feature game; and
upon conclusion of the second feature game:
generate a second feature game award; and
cause return to the base game mode including (i) cause the feature symbols to be removed from display in the second reel area, and (ii) cause display of a visual indication that the first reel area is reactivated while maintaining the display of the feature symbols in the first reel area when the first reel area does not include the triggering number of the feature symbols.

6. The electronic gaming machine of claim 1, wherein, in response to each of the first and second reel areas including the triggering number of the feature symbols, the instructions, when executed, further cause the game controller to:
initiate the feature game within each of the first and second reel areas; and
upon conclusion of the feature game:
generate the feature game award; and
cause return to the base game mode including cause the feature symbols to be removed from display in the first and second reel areas.

7. The electronic gaming machine of claim 6, wherein the feature game is a hold-and-spin feature game with an independent free spin reset for each of the first and second reel areas.

8. The electronic gaming machine of claim 7, wherein the instructions, when executed, further cause the game controller to determine that the feature game is concluded when, for each of the first and second reel areas, either: i) a number of remaining free spins of the feature game reaches zero, or ii) the respective reel area is completely populated with feature symbols.

9. The electronic gaming machine of claim 6, wherein the instructions, when executed, further cause the game controller to populate the feature symbols displayed in each of the first and second reel areas upon initiation of the feature game with identifiers indicative of corresponding feature values.

10. The electronic gaming machine of claim 9, wherein the feature values corresponding to the feature symbols displayed in each of the first and second reel areas are randomly selected from a common paytable stored in the at least one memory.

11. A non-transitory computer-readable medium containing instructions stored thereon, which when executed by a processor, cause the processor to:
control at least one display device to display an electronic game that includes a first reel area and a second reel area;
control the at least one display device to display a plurality of symbols including one or more feature symbols in each of the first and second reel areas as part of a base game in a base game mode;
determine that the first reel area includes a triggering number of the feature symbols displayed therein for triggering a feature game in a feature game mode;
initiate the feature game within the first reel area;
determine whether the second reel area includes the triggering number of the feature symbols displayed therein;
in response to the second reel area not including the triggering number of the feature symbols, control the at least one display device to display a visual indication that the second reel area is inactive for the feature game; and
upon conclusion of the feature game:
generate a feature game award; and
cause return to the base game mode including controlling the at least one display device to (i) remove the feature symbols from display in the first reel area, and (ii) display a visual indication that the second reel area is reactivated while maintaining the display of the feature symbols in the second reel area when the second reel area does not include the triggering number of the feature symbols.

12. The non-transitory computer-readable medium of claim 11, wherein the instructions, when executed, further cause the processor to evaluate both the first and second reel areas for a base game award when in the base game mode, wherein symbol positions of the first and second reel areas in which the feature symbols are displayed are precluded from forming a winning symbol combination for the base game award.

13. The non-transitory computer-readable medium of claim 11, wherein the instructions, when executed, further cause the processor to randomly select the plurality of symbols for display in each of the first and second reel areas from a common set of reel strips stored in the at least one memory.

14. The non-transitory computer-readable medium of claim 11, wherein the plurality of symbols is a first plurality of symbols, wherein the instructions, when executed, further cause the processor to:
control the at least one display device to display a second plurality of symbols in each of the first and second reel areas after return to the base game mode as part of a second base game, and wherein the second plurality of symbols includes the maintained display of the feature symbols in the second reel area when the first plurality of symbols does not include the triggering number of the feature symbols displayed in the second reel area;
determine that the second reel area includes the triggering number of the feature symbols of the second plurality of symbols displayed therein for triggering a second feature game in the feature game mode;
initiate the second feature game within the second reel area;
determine whether the first reel area includes the triggering number of the feature symbols of the second plurality of symbols displayed therein;
in response to the first reel area not including the triggering number of the feature symbols, cause display of a visual indication that the first reel area is inactive for the second feature game; and
upon conclusion of the second feature game:
generate a second feature game award; and
cause return to the base game mode including controlling the at least one display device to (i) remove the feature symbols from display in the second reel area, and (ii) display a visual indication that the first reel area is reactivated while maintaining the display of the feature symbols in the first reel area when the first reel area does not include the triggering number of the feature symbols.

15. The non-transitory computer-readable medium of claim 11, wherein, in response to each of the first and second reel areas including the triggering number of the feature symbols, the instructions, when executed, further cause the processor to:
initiate the feature game within each of the first and second reel areas; and
upon conclusion of the play of the feature game:
generate the feature game award; and
cause return to the base game mode including controlling the at least one display device to remove the feature symbols from display in the first and second reel areas.

16. A computer-implemented method for providing an electronic game on an electronic gaming device, the method comprising:
controlling at least one display device to display the electronic game that includes a first reel area and a second reel area;
controlling the at least one display device to display a plurality of symbols including one or more feature symbols in each of the first and second reel areas as part of a base game in a base game mode;
determining that the first reel area includes a triggering number of the feature symbols displayed therein for triggering a feature game in a feature game mode;
initiating the feature game within the first reel area;
determining whether the second reel area includes the triggering number of the feature symbols displayed therein;
in response to the second reel area not including the triggering number of the feature symbols, controlling the at least one display device to display a visual indication that the second reel area is inactive for the feature game; and
upon conclusion of the feature game:
generating a feature game award; and
causing return to the base game mode including controlling the at least one display device to (i) remove the feature symbols from display in the first reel area, and (ii) display a visual indication that the second reel area is reactivated while maintaining the display of the feature symbols in the second reel area when the second reel area does not include the triggering number of the feature symbols.

17. The method of claim 16, further comprising evaluating both the first and second reel areas for a base game award when in the base game mode, wherein symbol positions of the first and second reel areas in which the feature symbols are displayed are precluded from forming a winning symbol combination for the base game award.

18. The method of claim 16, further comprising randomly selecting the plurality of symbols for display in each of the first and second reel areas from a common set of reel strips stored in the at least one memory.

19. The method of claim 16, wherein the plurality of symbols is a first plurality of symbols, the method further comprising:
controlling the at least one display device to display a second plurality of symbols in each of the first and second reel areas after return to the base game mode as part of a second base game, and wherein the second plurality of symbols includes the maintained display of the feature symbols in the second reel area when the first plurality of symbols does not include the triggering number of the feature symbols displayed in the second reel area;
determining that the second reel area includes the triggering number of the feature symbols of the second plurality of symbols displayed therein for triggering a second feature game in the feature game mode;
initiating the second feature game within the second reel area;
determining whether the first reel area includes the triggering number of the feature symbols of the second plurality of symbols displayed therein;
in response to the first reel area not including the triggering number of the feature symbols, causing display of a visual indication that the first reel area is inactive for the second feature game; and
upon conclusion of the second feature game:
generating a second feature game award; and
causing return to the base game mode including controlling the at least one display device to (i) remove the feature symbols from display in the second reel area, and (ii) display a visual indication that the first reel area is reactivated while maintaining the display of the feature symbols in the first reel area when the first reel area does not include the triggering number of the feature symbols.

20. The method of claim 16, wherein, in response to each of the first and second reel areas including the triggering number of the feature symbols, the method further comprises:
initiating the feature game within each of the first and second reel areas; and
upon conclusion of the play of the feature game:
generating the feature game award; and
causing return to the base game mode including controlling the at least one display device to remove the feature symbols from display in the first and second reel areas.
